(19) United States
(12) Patent Application Publication
(10) Pub. No.: US 2007/0019165 A1
(43) Pub. Date: Jan. 25, 2007

(54) TIR PRISM for a projection display apparatus having a partially masked surface

(75) Inventor: Naofumi Ishikura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC VIEWTECHNOLOGY, LTD., Tokyo (JP)

(21) Appl. No.: 11/483,756

(22) Filed: Jul. 11, 2006

(30) Foreign Application Priority Data
Jul. 19, 2005 (JP) 2005-208436

(51) Int. Cl. G03B 21/00

(52) U.S. Cl. 353/33

(57) ABSTRACT

A projection display apparatus has: a TIR prism having a first prism surface, a second prism surface, and a third prism surface; a projection lens which is disposed opposite to the first prism surface; and an image display device which is disposed opposite to the second prism surface. The image display device reflects incident light in a first direction or in a second direction in accordance with an image signal. The first, second, and third prism surfaces are formed so as to define a modulated light path, wherein the light is reflected in the first direction, then is incident on the second prism surface, then is totally reflected internally on the third prism surface, then exits from the first prism surface, and then is incident on the projection lens along the modulated light path. The first prism surface includes a first effective light beam area and a first shield area for shielding the light, wherein the modulated light path passes through the first effective light beam area, and wherein the first shield area is formed on at least a part of the first prism surface except for the first effective light beam area.

The present application is based on, and claims priority from, J.P. Application No. 2005-208436, filed on Jul. 19, 2005, the disclosure of which is hereby incorporated by reference herein in its entirety.

### BACKGROUND OF THE INVENTION

1. Field of the Invention

The present invention relates to a projection display apparatus and a TIR (Total Internal Reflection) prism, and more particularly to the structure of a TIR prism which facilitates the removal of stray light.

2. Description of the Related Art

A projection display apparatus modulates incident light by means of an image display device, and projects the modulated light onto a screen through a projection lens to display an image. While liquid crystal display panels have been conventionally used for image display devices, DMDs (Digital Micro-mirror Device) have recently been used for a variety of applications. A DMD, which is an image display device having many micro-mirrors which are two-dimensionally arrayed, modulates light by individually tilting the mirrors by approximately +10 degrees (for ON) or −10 degrees (for OFF) in accordance with an image signal to change the reflection angle of the light. Prior art projection display apparatuses using a DMD are classified into the one-chip type and the three-chip type. In the one-chip type, light that exits from a light source is separated into color lights by a color filter in a time division manner, and each color light is sequentially modulated by a single DMD. The three-chip type has three DMDs for red light, blue light, and green light, respectively, and color lights are simultaneously modulated. The demand for the one-chip type has been increasing for general applications because of the simple structure and relatively low manufacturing cost. More than one type is known as the optical system for the one-chip type DMD, one of which employs a TIR prism that is arranged adjacent to a DMD.

In recent years, higher display quality has been increasingly required for a projection display apparatus, and there is an increasing need for high contrast and the prevention of stray light. For this purpose, Japanese Patent Laid-open Publication No. 2004-258439 discloses a projection display apparatus which has a light shield plate for shielding part of light flux. The light shield plate is arranged in an illumination optical system that supplies incident light to a DMD. The light shield plate is removably inserted between the assembly of lenses and a reflecting mirror which are arranged along a light path. Undesired light that is produced by DMDs which are in the OFF state, such as stray light, is prevented from entering a projection lens, leading to improvement in contrast.

Japanese Patent Laid-open Publication No. 50251/96 discloses an optical element for a fiber scope. A light shielding film, which shields undesired light beams which are reflected, is formed on a glass substrate by means of vapor deposition, and the substrate is attached to the emitting surface of a prism. The light shielding film is formed on and protrudes from the glass substrate in areas other than the prism area, so that a space is formed between the surface of the glass substrate on which the light shielding film is not deposited and the surface of the prism. According to this structure, stray light, which may enter an imager device that is arranged adjacent to the emitting surface, is limited, and a ghost image caused by the reflection is prevented.

However, a projection display apparatus having a TIR prism that is arranged adjacent to a DMD has the following disadvantages. In the DMD, the tilt angles of mirror elements are individually controlled to separate incident light into light flux which is to be incident on the projection lens (hereinafter called ON light flux), and light flux which is not to be incident on the projection lens (hereinafter called OFF light flux). The OFF light flux is not directly incident on the projection lens because the light path is different from that of the ON light flux. However, the OFF light flux is not shielded by the DMD, but is simply reflected in a direction that is different from the direction in which the ON light flux is reflected. Therefore, the OFF light flux also is incident on the TIR prism, as well as the ON light flux. Further, a condenser lens is often provided adjacent to the incident surface of the TIR prism. However, the light flux that is incident on the condenser lens from a light source is not perfectly parallel, but has an angle distribution around the main light beam. Therefore, the incident angle relative to the condenser lens varies depending on the locations in the cross-section of the light flux. Accordingly, part of the light flux may be reflected on the emitting surface of the condenser lens after it is incident on the condenser lens, and may enter the adjacent TIR prism from the condenser lens. Such light flux called “stray light” is repeatedly reflected inside the TIR prism, and part of the stray light may be incident on the projection lens.

In this specification, the stray light, different from light beams which are necessary for displaying an image on a screen, means light beams which are undesirable for displaying an image. The stray light is caused by the OFF light flux, reflected light flux etc., as mentioned above.

The stray light exists inside the TIR prism together with the ON light flux for displaying an image, as mentioned above, and may be projected onto a screen through the projection lens. The influence of the stray light is not conspicuous when projecting a bright image, but becomes conspicuous when projecting a dark image, resulting in inferior contrast and the occurrence of stray light on the screen. Although the best way is to radically eliminate the cause of the stray light, it is difficult to do so for a DMD-based system due to the principle of the system. This disadvantage is particularly conspicuous in a single TIR prism system, because the stray light tends to be more incident on a projection lens in a single TIR prism system.

### SUMMARY OF THE INVENTION

It is an object of the present invention to provide a projection display apparatus which is capable of preventing stray light that may be incident on a projection lens in order to improve contrast and to prevent the occurrence of stray light on a screen in a simple structure. It is another object of the present invention to provide a TIR prism which is useful for manufacturing such a projection display apparatus.

A projection display apparatus comprises: a TIR prism having a first prism surface, a second prism surface, and a third prism surface; a projection lens which is disposed opposite to said first prism surface; and an image display device which is disposed opposite to said second prism surface. The image display device reflects incident light in a first direction or in a second direction in accordance with an image signal. The first, second, and third prism surfaces are formed so as to define a modulated light path, wherein the light is reflected in the first direction, then is incident on said second prism surface, then is totally reflected internally on said third prism surface, then exits from said first prism surface, and then is incident on said projection lens along said modulated light path. The first prism surface includes a first effective light beam area and a first shield area for shielding the light, wherein said modulated light path passes through said first effective light beam area, and wherein said first shield area is formed on at least a part of said first prism surface except for said first effective light beam area.

The first shield area that is formed on the first prism surface limits the light that exits from the first prism surface such that the light exits only from the area on which the first shield area is not formed. Since the area on which the first shield area is not formed completely includes the first effective light beam area through which the modulated light path passes, the light that is essential for projecting an image through the projection lens is incident on the projection lens without being affected by the first shield area. On the other hand, stray light travels along a path that is different from the light path along which the light that is essential for projecting an image travels. The stray light that falls on the first shield area is prevented from exiting from the first shield area, and the total amount of the stray light can be reduced.

The projection display apparatus may further comprise a light source. Second and third prism surfaces of said TIR prism may be formed so as to define an incident light path, wherein the light exits from said light source, then is incident on said third prism surface, then exits from said second prism surface, and then is incident on said image display device along said incident light path, and said second prism surface may include a second effective light beam area and a second shield area for shielding the light, wherein said second effective light beam area envelops an area through which said incident light path passes and an area through which said modulated light path passes, and wherein said second shield area is formed on at least a part of said second prism surface except for said second effective light beam area.

In one embodiment, the TIR prism includes a condenser lens having a first lens surface and a second lens surface. The first lens surface is disposed opposite to said third prism surface of said TIR prism at least in an area through which said incident light path passes. The first and second lens surfaces are formed such that the light is incident on said second lens surface, then exits from said first lens surface, and then is incident on said third prism surface along said incident light path. The second lens surface includes a third effective light beam area and a third shield area for shielding the light, wherein said incident light path passes through said third effective light beam area, and wherein said third shielding is formed on at least a part of said second lens surface except for said third effective light beam area.

The TIR prism may have a top surface and a bottom surface both of which are substantially orthogonal to the first, second, and third prism surfaces. The bottom surface may be fixed to the projection display apparatus by an adhesive, and the top surface may be roughly ground. Roughly grinding means a process of forming small asperities on a surface, and, in the present invention, the asperities are represented by Ra=0.2 to 0.5 μm. Ra that is smaller than 0.2 μm is not preferable because the light passes through the top surface without being diffused and may cause stray light.

As described above, the present invention can provide a projection display apparatus which is capable of limiting stray light that may be incident on a projection lens in order to improve contrast and to prevent the occurrence of stray light on a screen in a simple structure. Further, the TIR prism of the present invention is useful for providing such a projection display apparatus.

The above and other objects, features and advantages of the present invention will become apparent from the following description with reference to the accompanying drawings which illustrate examples of the present invention.

### BRIEF DESCRIPTION OF THE DRAWINGS

FIG. 1 is a diagram generally illustrating the configuration of an embodiment of a projection display apparatus according to the present invention;

FIG. 2 is an enlarged view of a TIR prism shown in FIG. 1;

FIG. 3 is a schematic diagram illustrating the surfaces of a prism and a condenser lens;

FIG. 4 is a schematic diagram showing the effective light beam areas on the surfaces of the prism and the condenser lens;

FIG. 5 is a schematic diagram showing the light path around the third shield area;

FIG. 6 is a diagram showing the light path of a light beam that is incident on a masking material from the prism;

FIGS. 7A to 7B are schematic diagrams showing an exemplary light path of a light beam which appears on a screen as stray light;

FIGS. 8A to 8C are diagrams illustrating a modification to the prism;

FIG. 9 is a graph showing the relationship between the incident angle and the reflectivity for a light beam that is incident on boundary 2; and

FIG. 10 is a diagram illustrating the measurement points of illuminance.

### DETAILED DESCRIPTION OF THE INVENTION

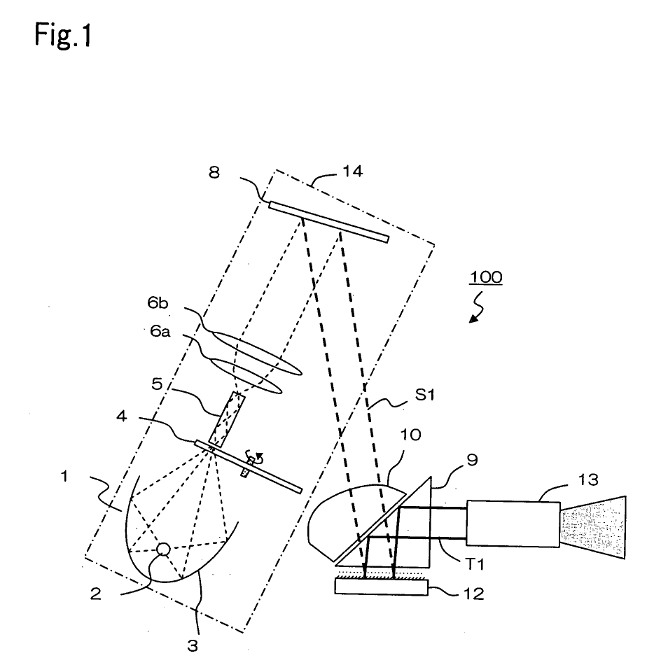

An embodiment of a projection display apparatus according to the present invention will be described with reference to the drawings. FIG. 1 is a diagram generally illustrating the configuration of an embodiment of the projection display apparatus according to the present invention. Projection display apparatus 100 has illumination optical system 14, TIR prism 9, projection lens 13, and image display device 12. Illumination optical system 14 includes light source 1.

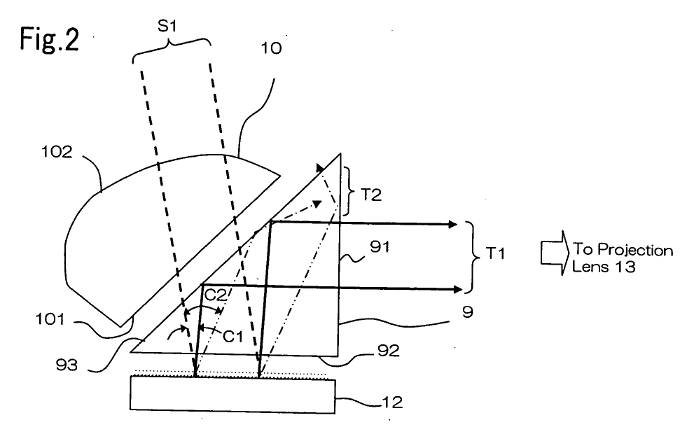

Illumination optical system 14 has lamp 2, which forms a part of light source 1, and reflector 3 which reflects light that exits from lamp 2 and makes the light converge on color wheel 4. Reflector 3 is arranged adjacent to light source 1, and color wheel 4 is arranged at the focal point of reflector 3. Color wheel 4 has three filters, not shown, for transmitting red light, blue light, and green light, respectively. Light flux that is emitted from lamp 2 sequentially passes through each rotating color filter in accordance with the rotation of color wheel 4, and is separated into red color light, blue color light, and green color light in a time division manner. Integrator rod 5 for smoothing the light flux is arranged on the emitting side of color wheel 4. Lenses 6a, 6b, which modify the light flux into parallel light flux having a predetermined cross-section, are arranged on the emitting side of integrator rod 5. Reflection mirror 8, which reflects the light flux such that it is incident on TIR prism 9, is arranged on the emitting side of lenses 6a, 6b. Projection lens 13 and image display device 12 are arranged opposite to prism surfaces 91, 92 (see FIG. 2) of TIR prism 9, respectively. The term “opposite” is not related to the distance between two components, but means the positional relationship between the components in which they face each other. Illumination optical system 14 is composed of the above-mentioned components starting from light source 1 ending with TIR prism 9.

The path along which light flux travels from reflection mirror 8 to image display device 12 is called “incident light path S1”, which is indicated by the bold broken lines in FIGS. 1, 2. Actually, incident light path S1 has a cross-section which has a thickness in the front-back direction of the drawing and which extends in two dimensions.

FIG. 2 is an enlarged view of a TIR prism. TIR prism 9 is a triangular prism in the form of an isosceles triangle. Condenser lens 10 is bonded to the surface of TIR prism 9 that is opposite to the apex of TIR prism 9. TIR prism 9 and condenser lens 10 are made of the same material. TIR prism 9 has first prism surface 91, second prism surface 92, and third prism surface 93. Condenser lens 10 has first lens surface 101 and second lens surface 102. First lens surface 101 of condenser lens 10 is opposite to third prism surface 93 of TIR prism 9.

Light flux, which travels from reflection mirror 8, is incident on condenser lens 10 along incident light path S1, as illustrated in FIG. 1. The light flux which travels along incident light path S1 is incident on second lens surface 102 of condenser lens 10, and exits from first lens surface 101 after traveling inside condenser lens 10. Then, the light flux is incident on third prism surface 93 of TIR prism 9.

The light flux, which is incident on third prism surface 93, exits from second prism surface 92 after traveling inside TIR prism 9, and is incident on image display device 12. Image display device 12 controls the tilt angle of the micro-mirrors in accordance with an image signal to reflect the incident light in a first direction (indicated by angle C1 in FIG. 2) or in a second direction (indicated by angle C2 in FIG. 2). The first direction is associated with the ON state of the mirror of image display device 12, while the second direction is associated with the OFF state of the mirrors of image display device 12. The light that is reflected in the first direction is again incident on second prism surface 92, and is totally reflected internally on third prism surface 93 to exit from first prism surface 91, and is incident on projection lens 13. The path along which the light flux travels from image display device 12, by which the light flux is reflected in the first direction, to projection lens 13, on which the light flux is incident, is called “modulated light path T1”, which is indicated by the bold solid lines in FIGS. 1, 2.

When the light flux is reflected in the second direction, the light flux is similarly incident on second prism surface 92 again. However, the light flux is reflected on the prism surface in a complicated manner. Such a path of the light flux is called “modulated light path T2”, which is indicated by thin dashed and dotted lines in FIG. 2. Part of the flux which travels along modulated light path T2 may reach first prism surface 91. It should be noted that a total black display is provided when all the mirrors of image display device 12 turn OFF so that entire light flux travels along modulated light path T2, while a total white display is provided when all the mirrors turn ON so that entire light flux travels along modulated light path T1.

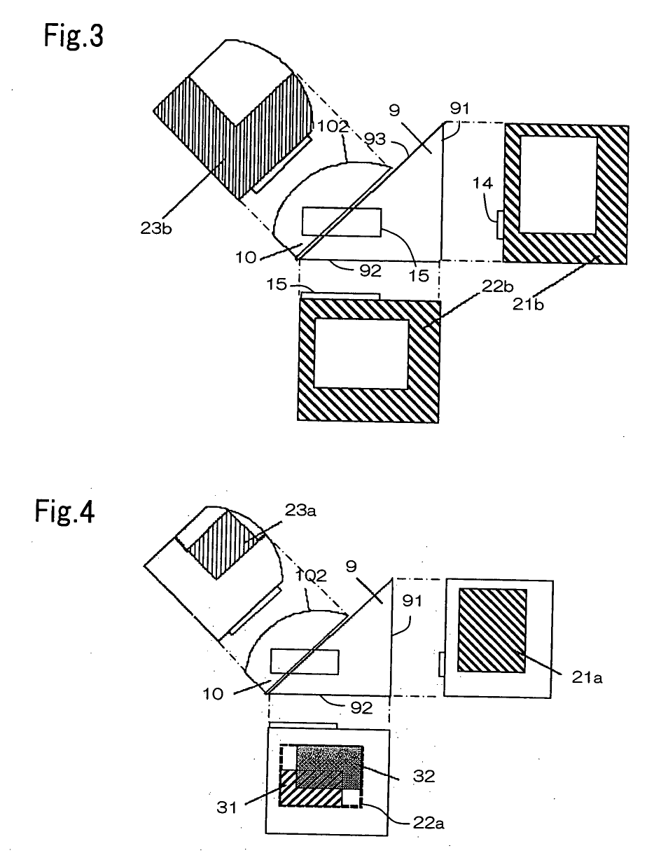

FIG. 3 illustrates the state of each surface of the prism and the condenser lens. FIG. 4 illustrates the effective light beam area on each surface of the prism and the condenser lens. In each figure, the central portion shows a top plan view of TIR prism 9, the right portion shows a side view of first prism surface 91 of prism 9, the lower portion shows a side view of second prism surface 92 of TIR prism 9, and the upper-left portion shows a side view of second lens surface 102 of condenser lens 10. TIR prism 9 and condenser lens 10 are integrated with each other, and are further reinforced with reinforcement member 15.

In the right portion, the lower portion, and the upper-left portion of FIG. 4, the hatched or black areas are shown. When light flux is incident on TIR prism 9, the light flux is first incident on second lens surface 102 of condenser lens 10. In this event, the area on which the light path is actually incident, or the area of second lens surface 102 through which incident light path S1 passes, occupies a part of the lens surface. This area is called third effective light beam area 23a.

Next, the light flux exits from second prism surface 92 of TIR prism 9, and is modulated by image display device 12 such that part of the light flux is turned ON, and the remaining light flux is turned OFF. Both light fluxes are incident on second prism surface 92 of TIR prism 9. The light flux that is required for displaying an image is the light flux that is incident on image display device 12 and the light flux that exits from image display device 12 in the ON state. Referring to the lower portion of FIG. 4, the area for the former light flux is shown as effective light beam area 31 for the incident light flux, and the area for the latter light flux is shown as effective light beam area 32 for the emitting light flux. The area which envelops areas 31, 32, or a part of second prism surface 92 which envelops the area through which incident light path S1 passes and the area through which modulated light path T1 passes, defines the area through which light fluxes for displaying an image pass. This area is called second effective light beam area 22a. Although second effective light beam area 22a is in a rectangular shape in FIG. 4 in order to facilitate the formation of the shield area, which will be described later, second effective light beam area 22a is not limited to a rectangular shape as long as it includes both areas 31, 32.

Then the light flux exits from first prism surface 91 of TIR prism 9. The area from which the light flux actually exits, or the area of first prism surface 91 through which modulated light path T1 passes occupies a part of the prism surface. This area is called first effective light beam area 21a.

It should be noted that these effective light beam areas 21a, 22a, 23a are required to allow the light beam for the total white display (ON-STATE light) to pass through, and therefore, light beam areas 21a, 22a, 23a are actually determined by the path of the light beam for the total white display which is incident on projection lens 13 along light path S1 and light path T1.

Referring next to FIG. 3, first shield area 21b for shielding light is formed on first prism surface 91 except for first effective light beam area 21a, as shown in the right portion of FIG. 3. Similarly, second shield area 22b for shielding light is formed on second prism surface 92 except for second effective light beam area 22a, as shown in the lower portion of FIG. 3. Third shield area 23b for shielding light is formed on second lens surface 102 except for third effective light beam area 23a, as shown in the upper-left portion of FIG. 3.

As mentioned above, effective light beam areas 21a-23a are not limited to rectangular shapes. However, since the shield areas are formed by coating, the shape of each shield area 21b-23b is preferably in a rectangular shape to facilitate easy coating. Specifically, shield areas 21b-23b are preferably in contact with effective light beam area 21a-23a, respectively, and are defined by straight lines that are parallel with the corresponding sides of the prism surface (or of the surface of the condenser lens). In addition, shield areas 21b-23b do not need to be completely complementary to respective effective light beam area 21a-23a. For example, if effective light beam area 23a is formed in a region of second lens surface 102 that is biased from the center of second lens surface 102 and that is closer to one edge, as illustrated in the upper-left portion of FIG. 4, then the shield area does not need to be formed along the side of effective light beam area 23a that is closer to the edge. In general, the shield area does not need to be formed along at least one side of the effective light beam area that is relatively close to the periphery of the prism surface or the lens surface in order to reduce coating work.

Next, the structure and the operation of each shield area will be described in detail one by one. For descriptive convenience, the third shield area will be described first according to the order in which light travels.

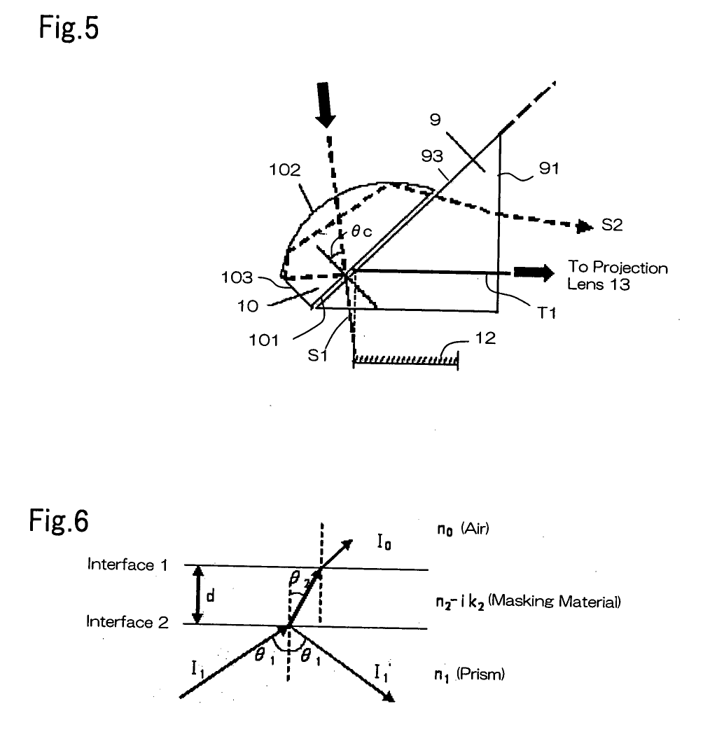

FIG. 5 shows the light path around the third shield area. FIG. 5 shows an exemplary light path of a light beam which appears on the screen as stray light, as well as incident light path S1. The light path of such stray light is called “incident light path S2.” Incident light paths S1, S2 may exist together in a projection display apparatus, because incident light is not always completely parallel or may have an angle distribution, as mentioned above, and therefore, the incident angle to condenser lens 10 varies depending on the locations. For example, the light flux in the left portion in FIG. 5 is prone to become stray light, or to travel along incident light path S2.

Assume that a light beam is incident on first lens surface 101 of condenser lens 10 at angle θc and that condenser lens 10 has refractive index n. If θc<sin⁻¹(1/n), then the light beam passes through first lens surface 101, and is incident on image display device 12. If θc≧sin⁻¹(1/n), then part of the light beam traveling toward image display device 12 through condenser lens 10 is totally reflected internally on the inner surface (first lens surface 101) of condenser lens 10. The light beam that was totally reflected internally on first lens surface 101 is totally reflected internally on third lens surface 103 and second lens surface 102. The light beam totally reflected internally on second lens surface 102 passes through third prism surface 93 and first prism surface 91 of TIR prism 9, and is incident on projection lens 13. This light beam appears on the screen as stray light, and therefore, needs to be shielded against projection lens 13. It should be noted that the total internal reflection of a light beam at a total internal reflection angle occurs only when the light flux exits from the prism to the air.

Accordingly, third shield area 23b is provided on second lens surface 102 of condenser lens 10 in order to shield the light beam which may be incident on projection lens 13 along incident light path S2. Third shield area 23b, as well as the other shield areas, is formed by coating a masking material on second lens surface 102. The masking material which constitutes third shield area 23b is required to satisfy the following conditions:

(1) Total internal reflection does not occur at the interface between the prism and the masking material.

(2) Reflectivity is low at the surface of the masking material.

(3) Transmittance of the masking material is low.

The term ‘prism’ refers to a triangular prism or a condenser lens. Although the following description about the third shield area will be given using the word ‘prism’, it should be noted that the prism means a lens in the description of the third shield area.

Next, a description will be given about a masking material which satisfies above conditions (1), (2), (3). FIG. 6 shows the light path of a light beam which is incident from a prism on a masking material. In the following description, the refractive index of air is represented by n₀, the refractive index of the prism is represented by n₁−ik₁, and the refractive index of the masking material is represented by n₂−ik₂, where i is the imaginary unit. If the prism is a perfect transmittable material, then the refractive index of the prism is equal to n1, because complex refractive index k1 becomes zero (k1=0). Assume that the masking material has a uniform absorptive property.

Condition (1) is satisfied if total internal reflection does not occur at interface 2, or n₁<n₂.

Condition (2) is satisfied if reflectivity R for a light beam that is incident on interface 2 on which the masking material is applied is equal to or lower than 10%. Assuming that the reflectivity of a p-polarized light beam is represented by Rp, and that the reflectivity of an s-polarized light beam is Rs, then Rp and Rs are expressed by:

$${R}_{p} = {R}_{s} \frac{{( a - {n}_{1} sin {θ}_{1} tan {θ}_{1} )}^{2} + {b}^{2}}{{( a + {n}_{1} sin {θ}_{1} tan {θ}_{1} )}^{2} + {b}^{2}}$$

$${R}_{s} = \frac{{( a - {n}_{1} cos {θ}_{1} )}^{2} + {b}^{2}}{{( a + {n}_{1} cos {θ}_{1} )}^{2} + {b}^{2}}$$

$$R = \frac{{R}_{P} + {R}_{s}}{2} \leq 0.1$$

$$where$$

$${a}^{2} = \frac{1}{2} \{ {[ {( {n}_{2}^{2} - {k}_{2}^{2} - {n}_{1}^{2} {sin}^{2} {θ}_{1} )}^{2} + 4 {n}_{2}^{2} {k}_{2}^{2} ]}^{\frac{1}{2}} + ( {n}_{2}^{2} - {k}_{2}^{2} - {n}_{1}^{2} {sin}^{2} {θ}_{1} ) \}$$

$${b}^{2} = \frac{1}{2} \{ {[ {( {n}_{2}^{2} - {k}_{2}^{2} - {n}_{1}^{2} {sin}^{2} {θ}_{1} )}^{2} + 4 {n}_{2}^{2} {k}_{2}^{2} ]}^{\frac{1}{2}} - ( {n}_{2}^{2} - {k}_{2}^{2} - {n}_{1}^{2} {sin}^{2} {θ}_{1} ) \}$$

Condition (3) is satisfied if transmittance T=T₀/T₁ for the light beam that passes through the masking material is equal to or lower than 10%. Assuming that the transmittance of a p-polarized light beam is represented by Tp, and the transmittance of an s-polarized light beam by Ts, then Tp and Ts are expressed by:

$${T}_{p} = \frac{{I}_{0 p}}{{I}_{1 p}} = \frac{{n}_{0} {t}_{1 p}^{2} {t}_{2 p}^{2}}{{n}_{1} ( 1 + {r}_{1 p}^{2} {r}_{2 p}^{2} + 2 {r}_{1 p} {r}_{2 p} cos δ )} \leq 0.1$$

$${T}_{s} = \frac{{I}_{0 s}}{{I}_{1 s}} = \frac{{n}_{0} {t}_{1 s}^{2} {t}_{2 s}^{2}}{{n}_{1} ( 1 + {r}_{1 s}^{2} {r}_{2 s}^{2} + 2 {r}_{1 s} {r}_{2 s} cos δ )} \leq 0.1$$

$$where$$

$$δ = \frac{4 π {n}_{2} d cos {θ}_{2}}{λ}$$

where λ is the wavelength of the light in vacuum, t1 is an amplitude transmittance at interface 1, t2 is an amplitude transmittance at interface 2, r1 is an amplitude reflectivity at interface 1, and r2 is an amplitude reflectivity at interface 2. I₀ represents the intensity of the light in the air layer, I₁ represents the intensity of the light in the prism, and suffixes p, s indicate a p-polarized and s-polarized light beam, respectively.

The reflectivity and the transmittance of the masking material at interface 2 should be limited to 10% or lower, because the stray light that has an intensity of 10% or less of that of the stray light which is clearly visible by the human eye cannot be visually perceived by the human eye, although this condition is limited only to a projector apparatus.

If the aforementioned conditions (1) to (3) are fully satisfied, then light beams that are reflected on the prism surfaces are absorbed or attenuated, and thereby the stray light which is caused by the TIR prism is reduced.

The essential feature is that the masking material which constitutes the shield area is in close contact with the prism surface. Specifically, it is necessary that the configuration, in which the masking material is in close contact with the prism surface without an air layer sandwiched therebetween, as illustrated in FIG. 6, is realized at least at the interface through which incident light path S1 passes. If the masking material is in close contact with the prism surface, the total internal reflection of a light beam on the inner surface of the prism is prevented, because the interface is defined by the prism and the masking material. As a result, diffused reflections are reduced on the inner surface of the prism, and light beams which may act as stray light can be easily removed. On the other hand, the prior art that is described in Japanese Patent Laid-open Publication No. 50251/96 is completely different from the embodiment of the present invention in that no condenser lens is provided, and in that no shield area, which is referred to as a light shielding film in above-mentioned document, is provided on the interface through which incident light path S1 passes, and further in that the interface is comprised of a prism, an air layer, and a glass substrate. In such a configuration in which the prism is in contact with an air layer, the light flux is totally reflected internally on the interface between the prism and the air layer. This results in a complicated reflection, as indicated by incident light path S2 in FIG. 5, and the effect of providing the shield area is not obtained. Specific materials for the masking material will be described in the following examples.

Next, a description will be given about the second shield area. The light beam that is incident on image display device 12 from the outside of second effective light beam area 22a is shielded by the masking material on second shield area 22b. Second shield area 22b also shields the light beam that is reflected on image display device 12 and that may otherwise be incident on projection lens 13 via the outside of second effective light beam area 22a. Further, second shield area 22b shields the light beam that passes along modulated light path T2, or the light beam that is turned OFF and that may otherwise pass through the outside of effective light beam area 22a on second prism surface 92 and that may be irradiated onto the screen by projection lens 13. In this way, stray light is more effectively removed, leading to an improvement in contrast. In addition, stray light on the screen is also prevented. Second prism surface 92 is masked under the same conditions as described above.

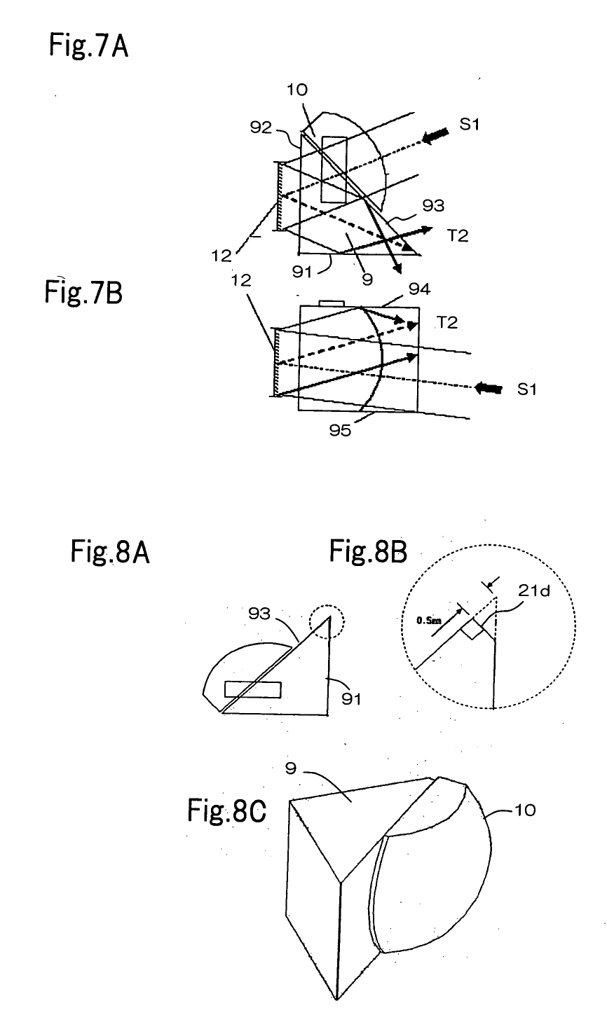

Next, a description will be given about the first shield area. FIG. 7 shows an exemplary light path (modulated light path T2) of a light beam which appears on the screen as stray light. FIG. 7A shows the top plan view of TIR prism 9, and FIG. 7B shows a side view of the same. TIR prism 9 has top surface 94 (the upper surface of the triangular prism) and bottom surface 95 (the lower surface of the triangular prism) both of which are substantially orthogonal to first, second, and third prism surfaces 91, 92, 93.

Part of the light flux that is reflected on image display device 12 and that travels along modulated light path T2 is irradiated onto third prism surface 93 and top surface 94 of the prism. The light flux is totally reflected internally on these surfaces and exits from first prism surface 91 to the outside of the prism. Part of the light flux that exits from first prism surface 91 is irradiated toward the projection lens. This light beam can be shielded and limited by the masking on first prism surface 91. As a result, the amount of light beam that is incident on the projection lens is reduced, and improvement in contrast is obtained.

If third prism surface 93 is additionally masked, then stray light that is incident on third prism surface 93 may be more effectively removed. However, third prism surface 93 has the function of ensuring that the light beam for displaying an image, which is reflected by image display device 12 and is incident on third prism surface 93, is totally reflected internally, as well as the function of guiding them onto projection lens 13. Masking third prism surface 93 prevents the light flux from being totally reflected internally on the inner surface of third prism surface 93, and this may result in a reduction in the amount of the light beam which is incident on projection lens 13. Accordingly, it is not preferable to mask third prism surface 93.

Part of the light flux that travels along modulated light path T2 may directly be incident on projection lens 13 from first prism surface 91. Such light flux is also shielded by the masking material on first prism surface 91. Since first prism surface 91 is located closest to the surface of projection lens 13 on which the light beam is incident, and therefore since a larger amount of light beam that may exit from the outside of the effective light beam area is shielded, masking first prism surface 91 is the most effective way to improve contrast. First prism surface 91 also is masked under the same conditions (1) to (3) as mentioned above.

Referring to FIG. 7, top surface 94 of the prism is roughly ground. As described above, part of the light flux that travels along modulated light path T2 is irradiated to top surface 94 of the prism, and is partially reflected on top surface 94 to be incident on projection lens 13. For this reason, top surface 94 is roughly ground so that part of the light flux that travels along modulated light path T2 and that is incident on top surface 94 is diffused. As a result, the amount of stray light that is incident on projection lens 13 is reduced. The amount of light beam that is incident on projection lens 13 is reduced in proportion to the roughness of top surface 94.

It may be one way to mask top surface 94 of the prism in order to completely shield the light flux which travels along modulated light path T2. However, the prism is fixed by an UV adhesive (ultra-violet ray curing adhesive) that is applied on the bottom surface of the prism when it is mounted to a projector. The UV adhesive is easy to use and thus manufacturing efficiency is improved because the amount of time needed for adhesion is short and because there is considerable flexibility in deciding the adhesion time. If top surface 94 of the prism is coated with a masking material, UV light for curing the UV adhesive would not effectively reach the adhesive. If UV light is irradiated from a side surface of the prism, the intensity of UV light would be significantly reduced because the UV light is irradiated in a direction oblique to the bottom surface. For those reasons, it is reasonable to finish (to roughly grind) top surface 94 of the prism such that the UV light passes through top surface 94 in order to irradiate the UV adhesive with UV light.

FIG. 8 shows an exemplary modification to the prism. FIG. 8A is a top plan view of the prism, FIG. 8B is an enlarged view of the circled portion in FIG. 8A, and FIG. 8C is a perspective view of the prism. As is also illustrated in FIG. 7, the light flux that travels along modulated light path T2 is generally reflected toward the edge portion between third prism surface 93 and first prism surface 91, and part of the light flux is incident on the edge portion. The light beam that is incident on the edge portion may also be reflected and may be incident on the projection lens. Thus, the edge portion between third prism surface 93 and first prism surface 91 is chamfered (cut away), and is masked to provide fourth shield area 21d. Masking the edge portion reduces diffused light beam which may occur at the edge portion and may be incident on the projection lens, and stray light is removed.

### EXAMPLE

Tests were conducted to study the conditions of the masking material and the surface of the shield area.

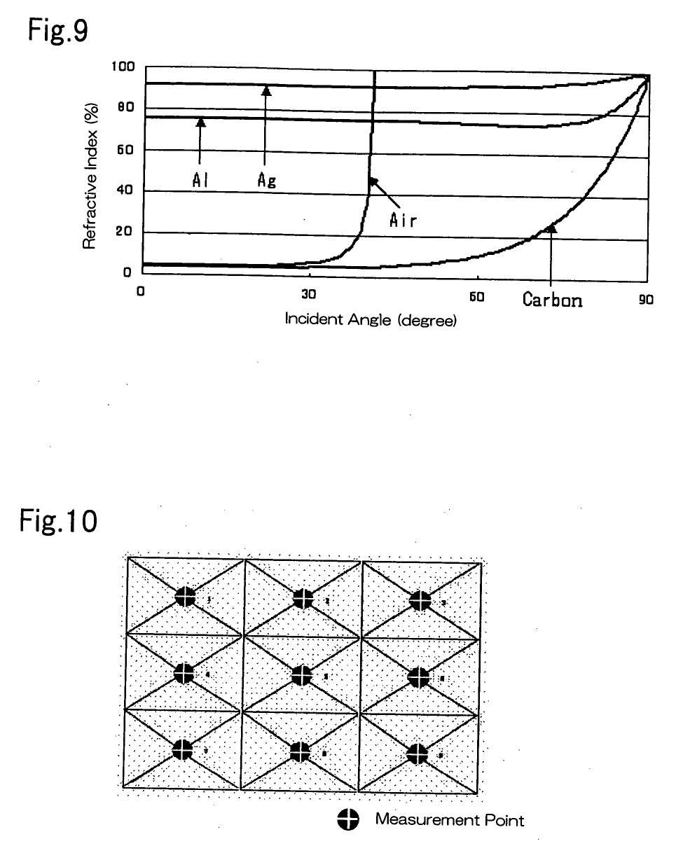

The first and the second prism surfaces of a prism and the second lens surface of a condenser lens were coated for masking. FIG. 9 shows the relationship between the incident angle and the reflectivity of a light beam that is incident on interface 2 (the masking material) which is shown in FIG. 6. Such materials as carbon (n₂=1.73, k₂=0.58), air (n₂=1, k₂=0), silver (n₂=0.20, k₂=3.44), and aluminum (n₂=1.44, k₂=5.23) are shown in FIG. 9 as examples of coating materials.

First, if the coating is formed of air (no coating) and n₁>n₂, then total internal reflection occurs on interface 2 for the incident angle that is equal to or larger than 41.2°. If the coating is formed of a metal such as silver or aluminum, then the light beam is not totally reflected internally on interface 2, because the refractive index is higher than that of the material of the prism. However, the reflectivity is very high irrespective of the incident angle. If the coating is formed of carbon, then the light beam is not totally reflected internally on interface 2, because the refractive index is higher than that of the material of the prism. In addition, the carbon coating exhibits a very low reflectivity, which is as low as several percents, compared with metals. Accordingly, materials that mainly contain carbon, or materials having a refractive index similar to that of carbon are useful as material for coating. In FIG. 9, the thickness of coating is assumed to be infinite, and the wavelength of the incident light beam is assumed to be 540 nm.

The thickness of the coating was chosen such that the light beam does not pass through the coating (several μm) because the coating material is required to shield the light beam. The coating was formed in the area that is shown in FIG. 3. The top surface of the prism was roughly ground to have an arithmetic mean roughness Ra that is 0.2 μm or more.

Table 1 shows the effects of the coating on the surfaces to a projected image. The contrast was represented by the ratio of the average illuminance, which was measured at nine points on a 100% totally white projected image, to the average illuminance, which was measured at the nine points on a 0% totally black projected image, in accordance with the Standard Document No. ANSI/NAPM IT 7.228-1997. The points for measuring illuminance are indicated by the black circles in FIG. 10. The coating on the first prism surface improved the contrast by 20% or more. The coatings on both the first and the second prism surfaces further improved the contrast. Even the coating on the second prism surface alone improved the contrast by 10% or more. The coating on the second lens surface of the condenser lens reduced stray light which would otherwise appear on the screen due to the total internal reflection on the inner surface of the second lens surface.

TABLE 1

| Area that is Masked | Effect to the projected image |
|---|---|
| First prism surface | Contrast 1134:1 => 1378:1 |
| Second prism surface | Contrast 1134:1 => 1264:1 |
| First and Second prism surfaces | Contrast 1134:1 => 1429:1 |
| Second lens surface | Stray light on the projected image |
| | reduced (The illuminance is reduced to |
| | 1/10 or less of that of the black |
| | projected image) |

As described above, by masking the prism surfaces and lens surface to form shield areas outside the effective light beam areas, the light flux that is turned OFF is less apt to be incident on the projection lens from the outside of the effective light beam areas of the prism surfaces and less apt to reach the screen. Accordingly, it is possible to improve the contrast, as well as to facilitate the removal of stray light which may appear on the screen due to the light which may be incident on the projection lens via similar light paths.

In particular, masking the outside of an effective light beam area on a surface of the TIR prism that is opposite to the projection lens enables a significant improvement in contrast. The contrast can also be improved by masking the outside of the effective light beam area on a surface of the TIR prism that is opposite to the image display device. Further, masking the outside of an effective light beam area on the surface of the condenser lens on which light beam is incident facilitates the removal of stray light in the projected image.

Although certain preferred embodiments of the present invention have been shown and described in detail, it should be understood that various changes and modifications may be made without departing from the spirit or scope of the appended claims.

What is claimed is:

1. A projection display apparatus comprising:
a TIR prism having a first prism surface, a second prism surface, and a third prism surface;
a projection lens which is disposed opposite to said first prism surface; and
an image display device which is disposed opposite to said second prism surface,
wherein said image display device reflects incident light in a first direction or in a second direction in accordance with an image signal,
wherein said first, second, and third prism surfaces are formed so as to define a modulated light path, wherein the light is reflected in the first direction, then is incident on said second prism surface, then is totally reflected internally on said third prism surface, then exits from said first prism surface, and then is incident on said projection lens along said modulated light path, and
wherein said first prism surface includes a first effective light beam area and a first shield area for shielding the light, wherein said modulated light path passes through said first effective light beam area, and wherein said first shield area is formed on at least a part of said first prism surface except for said first effective light beam area.

2. The projection display apparatus according to claim 1, further comprising a light source,
wherein said second and third prism surfaces of said TIR prism are formed so as to define an incident light path, wherein the light exits from said light source, then is incident on said third prism surface, then exits from said second prism surface, and then is incident on said image display device along said incident light path, and
wherein said second prism surface includes a second effective light beam area and a second shield area for shielding the light, wherein said second effective light beam area envelops an area through which said incident light path passes and an area through which said modulated light path passes, and wherein said second shield area is formed on at least a part of said second prism surface except for said second effective light beam area.

3. The projection display apparatus according to claim 2,
wherein said TIR prism includes a condenser lens having a first lens surface and a second lens surface,
wherein said first lens surface is disposed opposite to said third prism surface of said TIR prism at least in an area through which said incident light path passes,
wherein said first and second lens surfaces are formed such that the light is incident on said second lens surface, then exits from said first lens surface, and then is incident on said third prism surface along said incident light path, and
wherein said second lens surface includes a third effective light beam area and a third shield area for shielding the light, wherein said incident light path passes through said third effective light beam area, and wherein said third shielding is formed on at least a part of said second lens surface except for said third effective light beam area.

4. The projection display apparatus according to claim 1, wherein said first shield area mainly contains carbon.

5. The projection display apparatus according to claim 1, wherein said first shield area is formed by coating.

6. The projection display apparatus according to claim 1, wherein said first shield area exhibits a reflectivity and a transmittance both of which are 10% or less of the incident light.

7. The projection display apparatus according to claim 1,
wherein said first effective light beam area has a generally rectangular shape, and
wherein said first shield area is not formed along at least one of sides of said first effective light beam area, said one of the sides being relatively close to a peripheral edge of said prism surface.

8. The projection display apparatus according to claim 1,
wherein a chamfer is formed along an edge portion between said first prism surface and said third prism surface of said TIR prism, and
wherein said chamfer includes a fourth shield area for shielding the light which is formed thereon.

9. The projection apparatus according to claim 1,
wherein said TIR prism has a top surface and a bottom surface, said top surface and said bottom surface being substantially orthogonal to said first, second, and third prism surfaces,
wherein said bottom surface is fixed to said projection display apparatus by an adhesive, and
wherein said top surface is roughly ground.

10. A TIR prism comprising a first prism surface, a second prism surface, and a third prism surface,
wherein said first, second, and third prism surfaces are formed so as to define a modulated light path, wherein light is incident on said second prism surface, then is totally reflected internally on said third prism surface, and then exits from said first prism surface along said modulated light path, and
wherein said first prism surface includes a first effective light beam area and a first shield area for shielding the light, wherein said modulated light path passes through said first effective light beam area, and wherein said first shield area is formed on at least a part of said first prism surface except for said first effective light beam area.

11. The TIR prism according to claim 10,
wherein said second and third prism surfaces of said TIR prism are formed so as to define an incident light path, wherein the light is incident on said third prism surface, and then exits from said second prism surface along said incident light path, and
wherein said second prism surface includes a second effective light beam area and a second shield area for shielding the light, wherein said second effective light beam area envelops an area through which said incident light path passes and an area through which said modulated light path passes, and wherein said second shield area is formed on at least a part of said second prism surface except for said second effective light beam area.

12. The TIR prism according to claim 11, further comprising a condenser lens having a first lens surface and a second lens surface, and
wherein said first lens surface is disposed opposite to said third prism surface at least in an area through which said incident light path passes,
wherein said first and second lens surfaces are formed such that the light is incident on said second lens surface, then exits from said first lens surface, and then is incident on said third prism surface along said incident light path, and
wherein said second lens surface includes a third effective light beam area and a third shield area for shielding the light, wherein said incident light path passes through said third effective light beam area, and wherein said third shielding is formed on at least a part of said second lens surface except for said third effective light beam area.
